(19) United States
(12) Patent Application Publication
(10) Pub. No.: US 2021/0370690 A1
(43) Pub. Date: Dec. 2, 2021

(54) DRYING DEVICE AND LIQUID DISCHARGE APPARATUS INCORPORATING SAME

(71) Applicants: Toshiya SATOH, Kanagawa (JP); Naohiro TODA, Kanagawa (JP); Teiichiro ISHIKAWA, Tokyo (JP); Kohei FUNADA, Kanagawa (JP)

(72) Inventors: Toshiya SATOH, Kanagawa (JP); Naohiro TODA, Kanagawa (JP); Teiichiro ISHIKAWA, Tokyo (JP); Kohei FUNADA, Kanagawa (JP)

(73) Assignee: Ricoh Company, Ltd., Tokyo (JP)

(21) Appl. No.: 17/323,179

(22) Filed: May 18, 2021

(30) Foreign Application Priority Data
May 27, 2020 (JP) 2020-092536

(51) Int. Cl. B41J 11/00; B41J 15/04; B65H 18/16

(52) U.S. Cl. CPC B41J 11/0024; B41J 15/046; B65H 18/16; B65H 2801/21; B65H 2301/414; B65H 2404/144; B65H 2301/517

(57) ABSTRACT

A drying device includes a drum, a contact conveyance roller, and a cooling device. The drum heats a continuous medium while conveying the continuous medium. The continuous medium is wound around a circumferential surface of the drum. The contact conveyance roller contacts the drum at a downstream end of a portion of the continuous medium wound around the circumferential surface of the drum in a conveyance direction of the continuous medium. Further, the contact conveyance roller conveys the continuous medium separated from the drum. The continuous medium is wound around the contact conveyance roller. The cooling device cools the contact conveyance roller.

### CROSS-REFERENCE TO RELATED APPLICATION

This patent application is based on and claims priority pursuant to 35 U.S.C. § 119(a) to Japanese Patent Application No. 2020-092536, filed on May 27, 2020, in the Japan Patent Office, the entire disclosure of which is hereby incorporated by reference herein.

### BACKGROUND

### Technical Field

Aspects of the present disclosure relate to a drying device and a liquid discharge apparatus incorporating the drying device.

### Description of the Related Art

There is known a liquid discharge apparatus that discharges a liquid onto a sheet-shaped recording medium to form an image with a dot image of the liquid. A drying device dries and fixes the liquid adhering to the recording medium. In the drying device, the recording medium is wound around a conveyance drum (drum-shaped component) heated to a high temperature so that a back surface of the recording medium contacts the conveyance drum, thereby heating and drying the liquid by heat transfer. The liquid adheres to the surface opposite the back surface.

### SUMMARY

Embodiments of the present disclosure describe an improved drying device that includes a drum, a contact conveyance roller, and a cooling device. The drum heats a continuous medium while conveying the continuous medium. The continuous medium is wound around a circumferential surface of the drum. The contact conveyance roller contacts the drum at a downstream end of a portion of the continuous medium wound around the circumferential surface of the drum in a conveyance direction of the continuous medium. Further, the contact conveyance roller conveys the continuous medium separated from the drum. The continuous medium is wound around the contact conveyance roller. The cooling device cools the contact conveyance roller.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating an overall configuration of a printing system as an embodiment of a liquid discharge apparatus according to the present disclosure;

FIG. 2 is a schematic view illustrating an overall configuration of a drying device according to a first embodiment of the present disclosure;

FIG. 3 is a graph for explaining an effect of a sheet separation adjuster included in the drying device;

FIG. 4 is a schematic view illustrating an overall configuration of the drying device according to a second embodiment of the present disclosure;

FIG. 5 is a schematic view illustrating a configuration of a comparative example of the drying device according to the present disclosure; and

FIGS. 6A and 6B are diagrams for explaining a problem according to the comparative example.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

It is to be noted that the suffixes Y, M, C, and K attached to each reference numeral indicate only that components indicated thereby are used for forming yellow, magenta, cyan, and black images, respectively, and hereinafter may be omitted when color discrimination is not necessary.

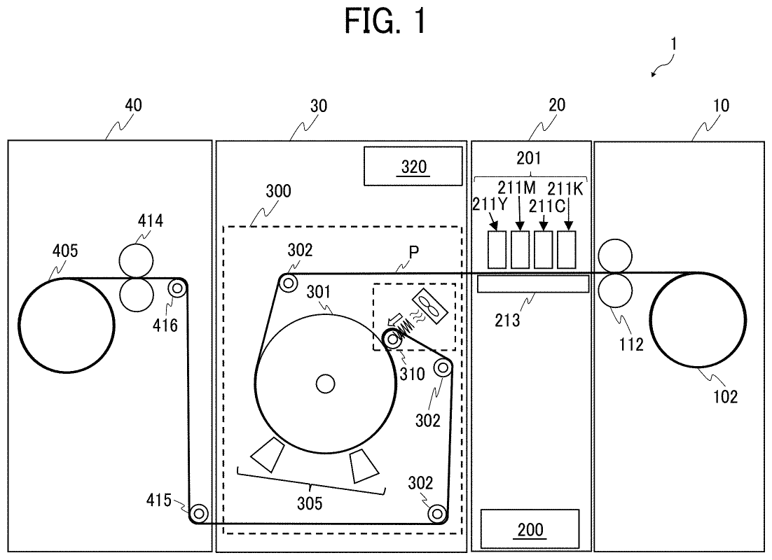

Hereinafter, a description is given of a printing system 1 as an embodiment of a liquid discharge apparatus according to the present disclosure with reference to the drawings. As illustrated in FIG. 1, the printing system 1 includes a sheet supply unit 10, an inkjet printer 20, a drying unit 30, and a sheet winding unit 40. The sheet supply unit 10 supplies a sheet P as a continuous medium. The drying unit 30 is an embodiment of a drying device according to the present disclosure. The sheet winding unit 40 winds the sheet P to carry out the sheet P after an image has been formed on the sheet P and the sheet P has been dried.

The sheet supply unit 10 supplies the sheet P, which is the sheet-shaped continuous recording medium, to the inkjet printer 20. The sheet P is an object to which a liquid is applied by the inkjet printer 20, and conveyed to the drying unit 30 to be dried. The sheet supply unit 10 includes a feed roller 102 that holds the sheet P and a conveyance roller pair 112 that conveys the sheet P toward the inkjet printer 20. Rotation speeds of the feed roller 102 and the conveyance roller pair 112 may be controlled by a controller 200 included in the inkjet printer 20 described below.

The inkjet printer 20 includes an image forming unit 201 as a liquid discharge unit. The sheet P is conveyed to the inkjet printer 20, and the inkjet printer 20 discharges and applies liquid ink to a predetermined position of the sheet P at a predetermined timing to form an image with a dot image of the liquid ink. Further, the inkjet printer 20 includes the controller 200 that controls image formation on the sheet P and conveyance of the sheet P along with the image formation. In addition to the operation of the inkjet printer 20, the controller 200 may also control operations of the sheet supply unit 10, the drying unit 30 described later, and the sheet winding unit 40.

The image forming unit 201 includes a liquid discharge head that discharges and applies liquid ink of a desired color onto the sheet P conveyed from the sheet supply unit 10. For example, the image forming unit 201 includes full-line type inkjet heads 211 corresponding to liquid inks of the respective colors used for the image formation, which are arranged in order from the upstream side in a conveyance direction of the sheet P. In FIG. 1, among the inkjet heads 211, a head 211K corresponds to black ink, a head 211C corresponds to cyan ink, a head 211M corresponds to magenta ink, and a head 211Y corresponds to yellow ink. With the liquid inks of four colors, an image is formed on the sheet P.

In FIG. 1, the head 211K, the head 211C, the head 211M, and the head 211Y are arranged in order from the upstream side in the conveyance direction of the sheet P. The order of arrangement is not limited thereto, and the head 211K, the head 211C, the head 211M, and the head 211Y can be arranged in any order. In addition, the inkjet heads 211 are not limited to a configuration corresponding to the liquid inks of the four colors, and the image forming unit 201 may further include an inkjet head 211 corresponding to liquid ink of different color.

In the sheet supply unit 10, the sheet P is fed from the feed roller 102, and the conveyance roller pair 112 delivers the sheet P onto a conveyance guide 213 of the inkjet printer 20. The conveyance guide 213 faces the image forming unit 201 and guides the sheet P conveyed in the inkjet printer 20.

The sheet winding unit 40 includes a winding roller 405, an output roller pair 414, a first guide roller 415, and a second guide roller 416. The sheet P to which the image forming unit 201 applies a liquid passes through the drying unit 30 and is guided by the first guide roller 415 and the second guide roller 416 in the sheet winding unit 40. The output roller pair 414 conveys the guided sheet P to the winding roller 405, and the winding roller 405 winds the sheet P around the winding roller 405.

Next, a description is given of the drying unit 30. The drying unit 30 is a device that dries a liquid (liquid ink) adhering to the sheet P. The drying unit 30 includes drying components 300 and a drying controller 320 that controls an operation of the drying components 300.

The drying components 300 includes a drum 301, multiple conveyance guide rollers 302, and a heating unit 305. The drum 301 forms an arc-shaped conveyance path around which the sheet P is wound. The conveyance guide rollers 302 guide the sheet P such that the sheet P comes in contact with a circumferential surface of the drum 301, and convey the sheet P separated from the circumferential surface of the drum 301 to the sheet winding unit 40. That is, the conveyance guide rollers 302 serve as a conveyance portion. The heating unit 305 disposed around the drum 301 heats the sheet P on the circumferential surface of the drum 301 to dry a liquid adhering to the surface of the sheet P. The multiple heating units 305 are arranged around the circumferential surface of the drum 301.

In the drying components 300, the sheet P is conveyed while contacting the circumferential surface of the drum 301, and heated by the drum 301 and the heating units 305 to dry a liquid adhering to the surface of the sheet P. The heating unit 305 heats the sheet P, for example, by electric heat, infrared, hot air, or the like. The drum 301 serves as a part of the conveyance portion to convey the sheet P, and also serves as a heating portion that applies a predetermined amount of heat to the sheet P to dry a liquid adhering to the surface of the sheet P. The circumferential surface of the drum 301 may be controlled at a predetermined temperature by a heat source inside the drum 301, for example.

The drying components 300 includes a sheet separation adjuster 310. The sheet separation adjuster 310 is disposed on the downstream side of the conveying path of the sheet P along the circumferential surface of the drum 301 to even heat transfer from the drum 301 to the sheet P when the sheet P separates from the drum 301. The sheet separation adjuster 310 applies a normal force of the sheet P to the circumferential surface of the drum 301 to even the heat transfer. The sheet separation adjuster 310 can prevent the uneven heat transfer to the sheet P at a position where the sheet P is separated from the drum 301, thereby preventing wrinkles of the sheet P from occurring.

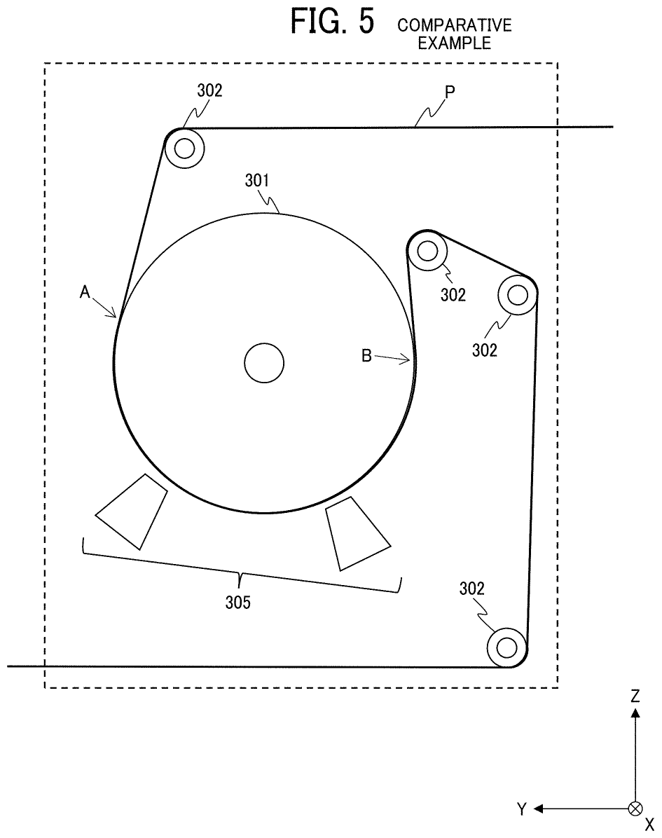

Here, the principle of the wrinkles of the sheet P is described with reference to a comparative example of the drying components 300 that does not include the sheet separation adjuster 310. As illustrated in FIG. 5, in the comparative example, the sheet P starts contacting the circumferential surface of the drum 301 at a position A. The sheet P is heated by the drum 301 and the heating units 305 while being conveyed on the circumferential surface of the drum 301 to dry a liquid adhering to the surface of the sheet P. Then, the sheet P is separated from the drum 301 at a position B. In this case, one of the locations where the sheet P is wrinkled is the position B where the sheet P wound around the drum 301 is separated from the drum 301.

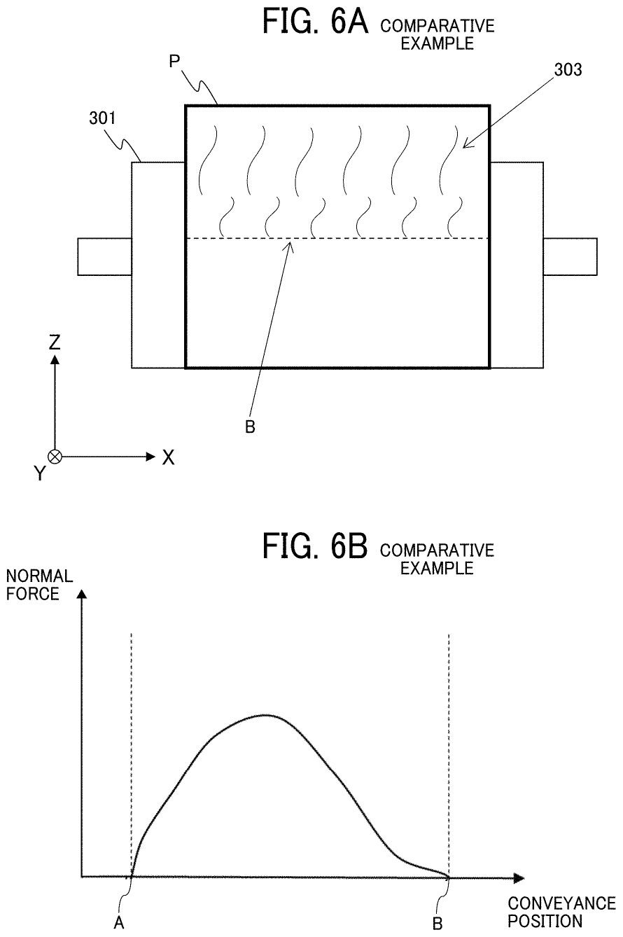

In an experiment, the temperature of the drum 301 was set to 95° C., and the sheet P stopped being conveyed in a state in which the sheet P was wound around the circumferential surface of the drum 301. In this state, the temperature of the circumferential surface of the drum 301 was lowered. Then, the sheet P was cut out and sampled, and each piece of the cut-out sheet P was observed to check the wrinkles at each portion of the sheet P that had been conveyed. As a result, wrinkles 303 is likely to occur downstream from the broken line illustrated in FIG. 6A in the conveyance direction. The broken line corresponds to the position B where the sheet P wound around the drum 301 is separated from the drum 301.

The principle of occurrence of the wrinkles 303 is generally assumed as follows based on the above experiment. First, in a winding region where the sheet P is wound around the drum 301, the degree of contact of the sheet P with the circumferential surface of the drum 301 is even. The degree of contact of the sheet P is expressed as a normal force of the sheet P to the drum 301 as described later. Therefore, thermal conduction to the sheet P in the winding region remains even. As a result, even if the thermal shrinkage of the sheet P occurs, the thermal shrinkage occurs evenly in the winding region, so that the wrinkles 303 do not occur.

On the other hand, when the sheet P is separated from the drum 301, the degree of contact of the sheet P with the circumferential surface of the drum 301 is weakened, and thus the sheet P unevenly contacts the circumferential surface of the drum 301. As a result, the thermal conduction to the sheet P near the position B becomes uneven, the thermal shrinkage of the sheet P occurs unevenly near the position B as a boundary, and the wrinkles 303 occur downstream from the position B.

As illustrated in the graph in FIG. 6B, the above-described phenomenon (occurrence of wrinkles) is explained by the relation between the position (conveyance position) on the circumferential surface of the drum 301 and the normal force of the sheet P to the circumferential surface of the drum 301. In the graph, the horizontal axis represents the conveyance position, and the vertical axis represents the normal force. As illustrated in FIG. 6B, the normal force gradually increases from the position A, reaches a peak at a certain position, and then gradually decreases toward the position B. Then, the normal force goes to 0 at the position B as a boundary and beyond. That is, the sheet P is separated from the circumferential surface of the drum 301 downstream from the position B.

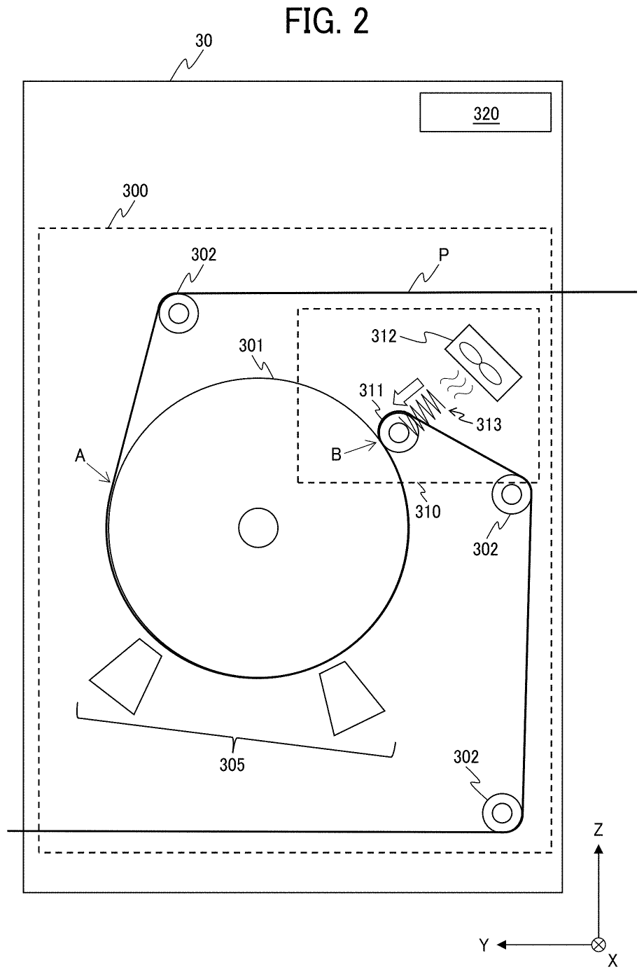

Next, a first embodiment of the drying unit 30 is described with reference to FIG. 2. As illustrated in FIG. 2, the sheet separation adjuster 310 included in the drying unit 30 according to the present embodiment includes at least a nip roller 311 serving as a contact conveyance roller, a cooling fan 312 serving as a cooling device, and a compression spring 313 serving as an elastic member and a pressing member.

The sheet separation adjuster 310 includes the nip roller 311 that contacts the drum 301 and rotates along with the drum 301 to prevent the occurrence of the wrinkles 303 (see FIG. 6) near the position B where the sheet P is separated from the drum 301. The nip roller 311 is formed of an elastic body such as rubber, and functions as a part of the conveyance portion to convey the sheet P downstream. The sheet P is separated from the drum 301 and wound around the circumferential surface of the nip roller 311. That is, the nip roller 311 contacts the drum 301 at a downstream end of a portion of the sheet P wound around the circumferential surface of the drum 301 in the conveyance direction of the sheet P.

The compression spring 313 biases the nip roller 311 toward the circumferential surface of the drum 301 to hold the nip roller 311. Therefore, the circumferential surface of the nip roller 311 is pressed against the circumferential surface of the drum 301. At this time, the pressing force of the nip roller 311 against the drum 301 is maintained by the biasing force of the compression spring 313 and the elastic force of the nip roller 311. That is, the nip roller 311 is held while being pressed against the drum 301 so that the nip roller 311 rotates along with the rotation of the drum 301. As the nip roller 311 rotates along with the drum 301, the sheet P separated from the drum 301 is wound around the circumferential surface of the nip roller 311 and conveyed by the nip roller 311.

A constant nip force, which causes the normal force of the sheet P to the drum 301, is applied to the sheet P and the drum 301 by the nip roller 311 of the sheet separation adjuster 310 until just before the sheet P is separated from the drum 301. Due to this nip force, the sheet P evenly contacts the drum 301 unlike the comparative example (see FIGS. 5, 6A, and 6B), that is, the contact unevenness between the sheet P and the drum 301 does not occur. Since the contact unevenness does not occur, heat is evenly transferred in the width direction of the sheet P, thereby preventing the wrinkles 303 as described in the comparative example from occurring.

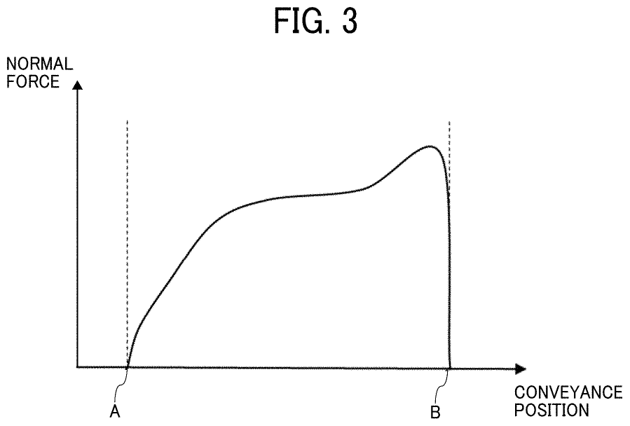

FIG. 3 is a graph illustrating the change of the normal force of the sheet P to the drum 301 in the drying unit 30 including the sheet separation adjuster 310. As illustrated in FIG. 3, in the present embodiment, the normal force remains high by the pressing force of the nip roller 311 until just before the sheet P is separated from the drum 301 (right in front of the position B). That is, the degree of contact of the sheet P with the circumferential surface of the drum 301 is stable until the sheet P reaches the position B, thereby preventing the uneven thermal shrinkage of the sheet P described in the comparative example due to the contact unevenness.

After the sheet P is wound around the nip roller 311, the temperature of the nip roller 311 becomes lower than the temperature of the drum 301 at a position where the sheet P is separated from the nip roller 311. Therefore, even if the contact unevenness occurs between the sheet P and the nip roller 311, the thermal stress of the sheet P is small. For example, even if the temperature of the drum 301 is 95° C., the temperature of the nip roller 311 is 50° C. or less. That is, even if the uneven thermal shrinkage occurs across the position where the sheet P is separated from the nip roller 311 as a boundary, the wrinkles 303 is unlikely to occur because the thermal stress of the sheet P is small.

As described above, in the drying unit 30 according to the present embodiment, the temperature of the sheet P is increased to a high temperature to dry a liquid adhering to the sheet P while the sheet P is conveyed on the drum 301. Then, the temperature of the sheet P can be sufficiently lowered when the sheet P is separated from the nip roller 311. Thus, the nip roller 311 alleviates the temperature change of the sheet P on the downstream side of the position B where the wrinkles due to the uneven thermal shrinkage is likely to occur. In addition, the nip roller 311 is held while being pressed against the drum 301. Accordingly, the degree of contact between the sheet P and the drum 301 can be maintained in a region where the degree of contact (normal force) of the sheet P with the drum 301 is likely to be weak. As a result, the wrinkles of the sheet P due to the uneven thermal shrinkage after being separated from the drum 301 can be prevented from occurring.

If the drying unit 30 is operated for a long time to continue the drying process, the temperature of the nip roller 311 in contact with the drum 301 may rise. For example, if the temperature of the nip roller 311 is increased to 80° C. while the drying process continues for one hour, the wrinkles may occur when the sheet P is separated from the nip roller 311, similarly to the situation when the sheet P is separated from the drum 301 without the nip roller 311. Therefore, the sheet separation adjuster 310 includes the cooling fan 312 that cools the nip roller 311. The cooling fan 312 includes a blower that blows natural air onto the nip roller 311.

The cooling fan 312 has a cooling capacity that can prevent the wrinkles from occurring when the sheet P is separated from the nip roller 311. The cooling fan 312 blows air having the quantity and speed of airflow that can maintain the temperature of the nip roller 311 at 70° C. or lower, for example. If the temperature of the nip roller 311 excessively rises even though the cooling fan 312 blows the natural air, a water cooling mechanism may be further provided to cool the nip roller 311.

As described above, the sheet separation adjuster 310 according to the present embodiment can prevent the wrinkles 303 as described in the comparative example from occurring and can stabilize the quality of the sheet P even when the drying unit 30 is operated over a long period of time.

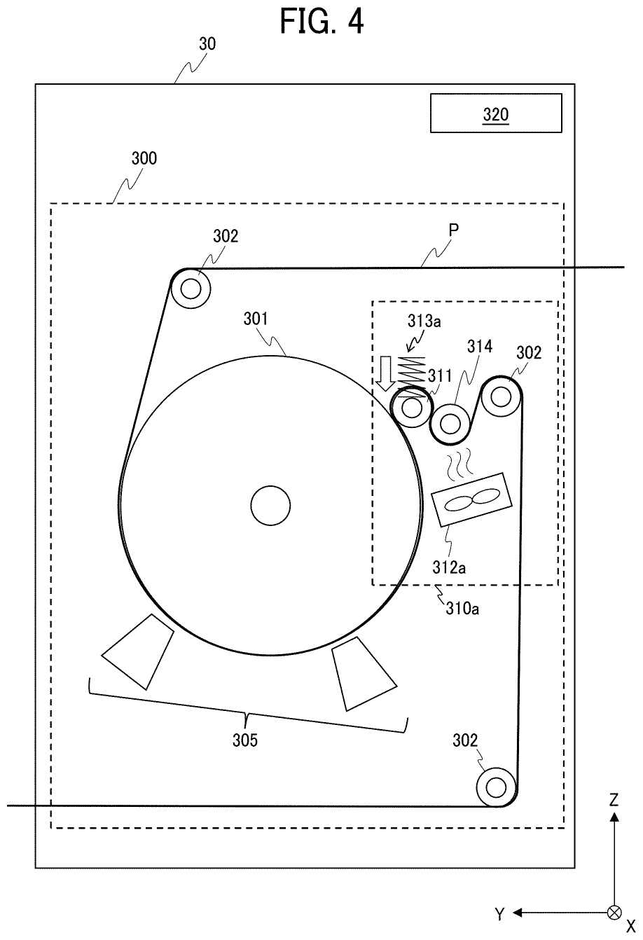

Next, a second embodiment of the drying unit 30 is described with reference to FIG. 4. As illustrated in FIG. 4, a sheet separation adjuster 310a included in the drying unit 30 according to the present embodiment includes at least the nip roller 311, a cooling fan 312a, a compression spring 313a as an elastic member, and a nip guide roller 314 as another contact conveyance roller.

With the sheet separation adjuster 310 according to the first embodiment, the cooling fan 312 cools the nip roller 311 in contact with the drum 301 to prevent the uneven thermal shrinkage of the sheet P. Here, focusing on the amount of heat of the drum 301, heat is transferred from the drum 301 to the nip roller 311 due to the contact between the drum 301 and the nip roller 311. To compensate heat loss transferred to the nip roller 311, the set temperature of the drum 301 may be raised. However, in this case, the energy efficiency may deteriorate because the energy consumption is increased in order to increase the amount of heat of the drum 301 and maintain the drum 301 at a predetermined temperature.

In view of the above, the sheet separation adjuster 310a according to the second embodiment includes the nip guide roller 314 that contacts the nip roller 311 at a downstream end of a portion of the sheet P wound around the nip roller 311 in the conveyance direction. The nip roller 311 and the nip guide roller 314 is pressed against each other. The nip guide roller 314 serves as a part of the conveyance path along which the sheet P separated from the drum 301 is wound around the nip roller 311 and conveyed. The sheet P is conveyed to the conveyance guide roller 302 via the nip guide roller 314.

In the sheet separation adjuster 310a, the sheet P separated from the nip roller 311 is wound around the nip guide roller 314, similarly to the conveyance path along which the sheet P is conveyed from the drum 301 toward the nip roller 311. Since the nip roller 311 and the nip guide roller 314 are pressed against each other with a certain pressing force, an even pressure is also applied to the sheet P interposed therebetween. Therefore, the sheet P evenly contacts the nip roller 311 on the conveyance path from the nip roller 311 to the nip guide roller 314, thereby evenly transferring heat to the sheet P. As a result, the wrinkles of the sheet P, which occur at the position where the sheet P separated from the drum 301 as a boundary, as described in the comparative example can be prevented from occurring.

The temperature of the nip guide roller 314 at a position where the sheet P is separated from the nip guide roller 314 is lower than the temperature of the nip roller 311, below which the wrinkles do not occur. Therefore, the wrinkles of the sheet P can be prevented from occurring downstream from the position at which the sheet P is separated from the nip guide roller 314 in the conveyance direction.

For example, even if the temperature of the drum 301 is 95° C. and the temperature of the nip roller 311 is increased to 80° C. in the continuous operation without cooling the nip roller 311, the temperature of the nip guide roller 314 disposed next to the nip roller 311 is increased to only about 60° C. Therefore, the uneven heat shrinkage does not occur, and the wrinkles can be prevented from occurring downstream from the nip guide roller 314.

In addition, according to the sheet separation adjuster 310a, a large amount of heat is not transferred from the drum 301, and the wrinkles can be prevented from occurring, thereby improving the energy efficiency.

The nip roller 311 is sandwiched between the drum 301 and the nip guide roller 314. The positions of axes of the drum 301 and the nip guide roller 314 are fixed, and the position of axis of the nip roller 311 is free (is not fixed) in the sheet separation adjuster 310a. The nip roller 311 is held while being pressed against the drum 301 and the nip guide roller 314 by the weight thereof or the pressing force of the compression spring 313a to secure the position of axis of the nip roller 311. Various configurations are applicable to the nip guide roller 314, and an example thereof is a rod-shaped component including a cylindrical portion made of metal such as aluminum, a ball bearing, and a shaft.

The nip roller 311 rotates along with the rotation of the drum 301 due to the frictional force with the drum 301. The nip guide roller 314 rotates along with the rotation of the nip roller 311 due to the frictional force with the nip roller 311. That is, the drum 301 and the nip roller 311 are arranged so that the nip roller 311 is driven by the drum 301 along the tangential direction between the drum 301 and the nip roller 311, and the nip roller 311 and the nip guide roller 314 are arranged so that the nip guide roller 314 is driven by the nip roller 311 along the tangential direction between the nip roller 311 and the nip guide roller 314. This configuration prevents the fluctuation of the pressing force due to the runout of the drum 301, the nip roller 311, or the nip guide roller 314. As a result, a nip pressure (degree of contact) can remain stable, thereby preventing the wrinkles of the sheet P from occurring.

In addition, it is unnecessary to strictly control tolerances of the position of axis and the runout of the three rotators (i.e., the drum 301, the nip roller 311, and the nip guide roller 314), thereby preventing the wrinkles with the inexpensive configuration.

Similarly to the first embodiment, if the drying unit 30 is operated for a long time to continue the drying process, the temperature of the nip roller 311 in contact with the drum 301 may rise, and the temperature of the nip guide roller 314 in contact with the nip roller 311 may rise. Therefore, the sheet separation adjuster 310a includes the cooling fan 312a that cools the nip roller 311 and the nip guide roller 314 to suppress the temperature rise of the nip roller 311 and the nip guide roller 314. The cooling fan 312a is a blower that blows natural air onto the nip roller 311 and the nip guide roller 314.

In the sheet separation adjuster 310a, the nip roller 311 is disposed between the drum 301 and the nip guide roller 314. With this configuration, the temperature of the sheet P progressively drops from upstream to downstream in the conveyance direction of the sheet P. Therefore, the cooling capacity of the cooling fan 312a may be lower than that of the first embodiment. That is, in the second embodiment, the energy efficiency can be further improved as compared with the first embodiment.

As described above, according to the present disclosure, the drying device that dries the recording medium can prevent the quality of the recording medium from deteriorating.

The present disclosure is not limited to specific embodiments described above, and numerous additional modifications and variations are possible in light of the teachings within the technical scope of the appended claims. It is therefore to be understood that, the disclosure of the present specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

What is claimed is:

1. A drying device comprising:
a drum configured to heat a continuous medium while conveying the continuous medium, the continuous medium being wound around a circumferential surface of the drum;
a contact conveyance roller configured to:
contact the drum at a downstream end of a portion of the continuous medium wound around the circumferential surface of the drum in a conveyance direction of the continuous medium; and
convey the continuous medium separated from the drum, the continuous medium being wound around the contact conveyance roller; and
a cooling device configured to cool the contact conveyance roller.

2. The drying device according to claim 1, further comprising another contact conveyance roller configured to contact the contact conveyance roller,
wherein the contact conveyance roller is configured to press against the drum and said another contact conveyance roller to secure a position of an axis of the contact conveyance roller,
wherein the contact conveyance roller is configured to rotate along with a rotation of the drum, and
wherein said another contact conveyance roller is configured to rotate along with a rotation of the contact conveyance roller.

3. The drying device according to claim 2, further comprising a pressing member configured to press the contact conveyance roller against the drum.

4. The drying device according to claim 3,
wherein the pressing member is a compression spring.

5. The drying device according to claim 1,
wherein the cooling device includes a blower that blows air onto the contact conveyance roller.

6. A liquid discharge apparatus comprising:
a liquid discharge unit configured to discharge a liquid onto a continuous medium; and
the drying device according to claim 1, configured to dry the liquid adhering to the continuous medium.
